(19) United States
(12) Patent Application Publication
(10) Pub. No.: US 2022/0201801 A1
(43) Pub. Date: Jun. 23, 2022

(54) HEATING ELEMENT COMPRISING ONE-WAY VALVE

(71) Applicant: Shenzhen Eigate Technology Co., Ltd., Shenzhen (CN)

(72) Inventor: Tuanfang LIU, Shenzhen (CN)

(21) Appl. No.: 17/351,163

(22) Filed: Jun. 17, 2021

(30) Foreign Application Priority Data
Dec. 21, 2020 (CN) 202011517990.8
Dec. 21, 2020 (CN) 202023094079.9

(51) Int. Cl. H05B 1/02; A24F 40/46; A24F 40/10; A24F 40/485; F22B 1/28

(52) U.S. Cl. CPC H05B 1/0297; A24F 40/46; F22B 1/284; A24F 40/485; A24F 40/10

(57) ABSTRACT

A heating element, including a body and a heating wire. The body is in the shape of a cylinder and includes a central through hole; and at least two pins are soldered on two ends of the heating wire, respectively.

### CROSS-REFERENCE TO RELATED APPLICATIONS

Pursuant to 35 U.S.C. § 119 and the Paris Convention Treaty, this application claims foreign priority to Chinese Patent Application No. 202011517990.8 filed Dec. 21, 2020, and to Chinese Patent Application No. 202023094079.9 filed Dec. 21, 2020. The contents of all of the aforementioned applications, including any intervening amendments thereto, are incorporated herein by reference.

### BACKGROUND

The disclosure relates to a heating element.

Conventionally, a heating element for an electronic cigarette comprises a cylindrical body comprising one or two through holes, and at least one heating wire vertically wound in the through hole. To fix the at least one heating wire in the through hole, the heating element further comprises a support and a guide tube. Thus, the heating element is costly.

### SUMMARY

The disclosure provides a heating element comprising a body and a heating wire; the body is in the shape of a cylinder and comprises a central through hole; and at least two pins are soldered on two ends of the heating wire, respectively.

In a class of this embodiment, the heating wire is a flat structure disposed on a bottom of the body.

In a class of this embodiment, the heating wire further comprises at least one alloy wire in the shape of planar sieve, network, or lattice disposed on the bottom of the body or around the periphery of the body in parallel or in series; and two pins are soldered on two ends of the heating wire, respectively.

In a class of this embodiment, the body comprises an upper surface comprising a plurality of grooves for removal of air bubbles formed in the process of loading e-liquid.

In a class of this embodiment, the central through hole is configured to guide vapor and is in the shape of a circle, ellipse, triangle, quadrilateral, polygon, or mesh.

In a class of this embodiment, the body is in the shape of a cylinder, an ellipsoid, a runway, a hemisphere, a cone, a bowl, a triangle, a quadrilateral, or a polygon, and the body comprises quartz, crystal, mica, agate, or jade.

The disclosure also provides an atomizer comprising the aforesaid heating element.

### BRIEF DESCRIPTION OF THE DRAWINGS

FIG. 1 is an exploded view of a heating element according to one embodiment of the disclosure;

FIG. 2 is a schematic diagram of a heating element according to one embodiment of the disclosure; and

FIG. 3 is a sectional view of a heating element according to one embodiment of the disclosure.

### DETAILED DESCRIPTION

To further illustrate, embodiments detailing a one-way valve are described below. It should be noted that the following embodiments are intended to describe and not to limit the disclosure.

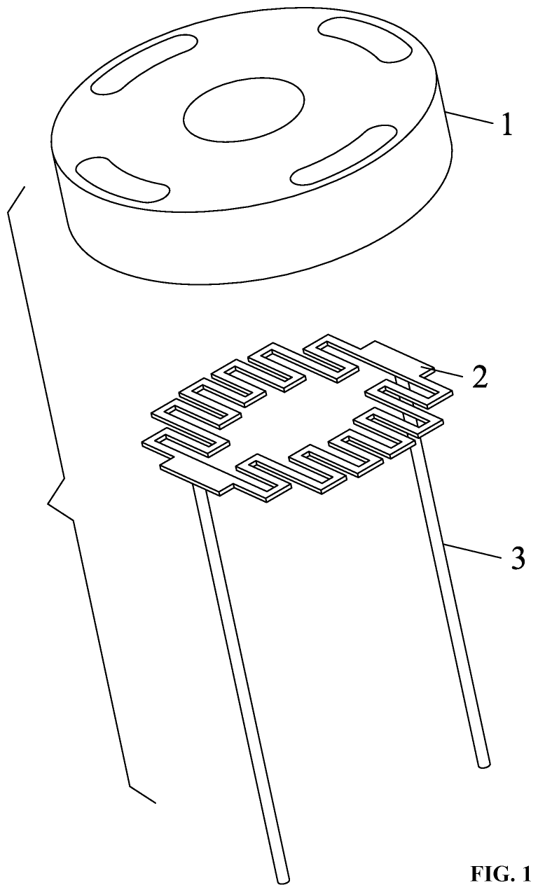

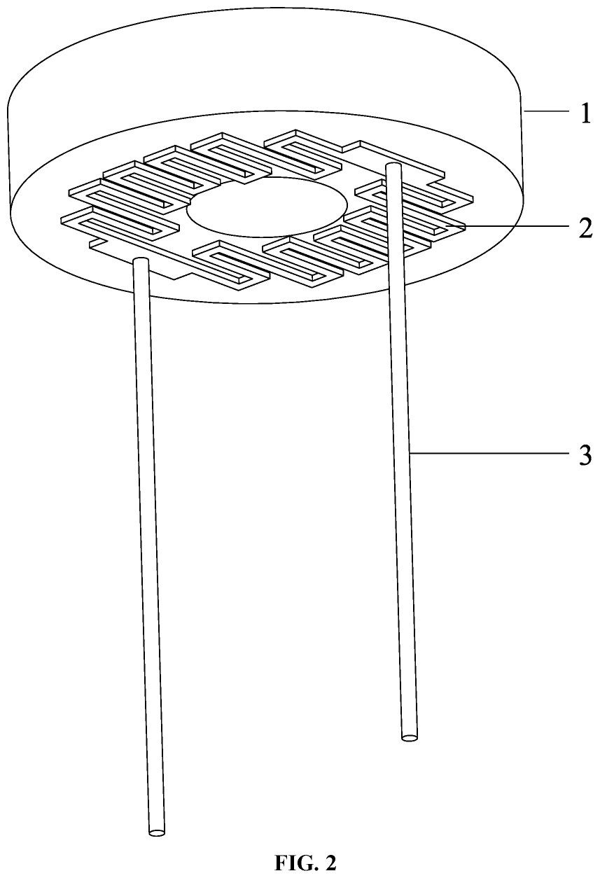

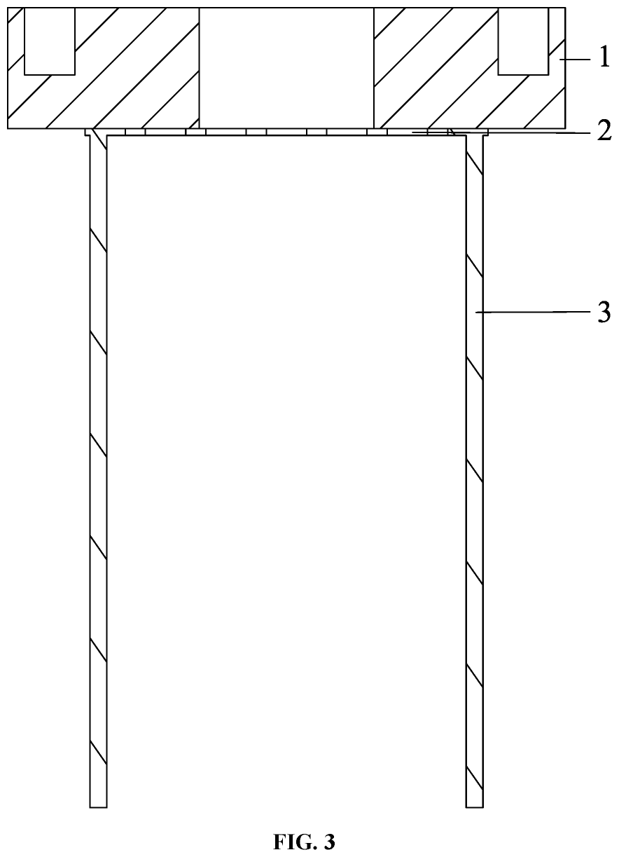

As shown in FIGS. 1-3, the disclosure provides a heating element comprising a body 1 and a heating wire 2. The body is in the shape of a cylinder and comprises a central through hole. Two pins 3 are soldered on two ends of the heating wire, respectively. The heating wire 2 is a flat structure comprising a metal wire which is bent and coiled back and forth in one plane. The heating wire 2 is disposed on the bottom of the body 1. When in use, the heating element is disposed in an atomizer and the heating wire 2 is electrified to produce heat. The heat is transferred to the body 1 to heat the e-liquid to produce vapor. A tube is inserted into the central through hole to guide the vapor. Specifically, the air is introduced via the central through hole into the body to drive the produced vapor to flow from the tube to an air passage for user's inhalation.

In certain embodiments, the body 1 comprises quartz, crystal, mica, jade or the like. The body 1 is a cylinder, a square, a hemisphere, a cone or a polygon. The central through hole is in the shape of a circle, ellipse, triangle, quadrilateral, polygon, or mesh. The heating wire can be more than two alloy wires in the shape of planar sieve, network, or lattice disposed on the bottom of the body or around the periphery of the body in parallel or in series.

The following advantages are associated with the heating element of the disclosure:

1. The shape of the heating element is designed as a cylinder comprising a central through hole. Upon assembly of an atomizer, a tube is fixed in the central through hole of the heating element. The heating element is easily disposed in the atomizer through the tube, and the air enters the heating element and vapor flows out the heating element via the tube, no need to design a support for the heating element and a guide tube as a conventional atomize does.

2. The heating wire is a flat structure comprising a metal wire which is bent and coiled back and forth in one plane and is disposed on the bottom of the body. Compared with a conventional heating wire which is vertically wound in the through hole of the body, the heating element of the disclosure is novel and efficient.

3. The body comprises an upper surface comprising a plurality of grooves for removal of air bubbles formed in the process of loading e-liquid. Thus, an atomizer comprising the heating element has a large heating area, fast e-liquid loading and produces more vapor.

It will be obvious to those skilled in the art that changes and modifications may be made, and therefore, the aim in the appended claims is to cover all such changes and modifications.

What is claimed is:

1. A heating element, comprising a body and a heating wire; the body is in the shape of a cylinder and comprises a central through hole; and at least two pins are soldered on two ends of the heating wire, respectively.

2. The heating element of claim 1, wherein the heating wire is a flat structure disposed on a bottom of the body.

3. The heating element of claim 2, wherein the heating wire further comprises at least one alloy wire in the shape of planar sieve, network, or lattice disposed on the bottom of the body or around the periphery of the body in parallel or in series; and two pins are soldered on two ends of the heating wire, respectively.

4. The heating element of claim 1, wherein the body comprises an upper surface comprising a plurality of grooves for removal of air bubbles formed in the process of loading e-liquid.

5. The heating element of claim 1, wherein the central through hole is configured to guide vapor and is in the shape of a circle, ellipse, triangle, quadrilateral, polygon, or mesh.

6. The heating element of claim 1, wherein the body is in the shape of a cylinder, an ellipsoid, a runway, a hemisphere, a cone, a bowl, a triangle, a quadrilateral, or a polygon, and the body comprises quartz, crystal, mica, agate, or jade.

7. An atomizer, comprising the heating element of claim 1.
